(19) United States
(12) Patent Application Publication
(10) Pub. No.: US 2026/0243234 A1
(43) Pub. Date: Aug. 20, 2026

(54) GEOTHERMAL POWER SYSTEMS AND PROCESSES

(71) Applicant: Sage Geosystems Inc., Houston, TX (US)

(72) Inventors: Lev M. RING, Bellaire, TX (US); Robert Lance COOK, Houston, TX (US); Douglas SIMPKINS, Houston, TX (US)

(21) Appl. No.: 19/162,462

(22) PCT Filed: Mar. 8, 2024
(86) PCT No.: PCT/US2024/019190

§ 371 Date: Sep. 5, 2025

Related U.S. Application Data
(60) Provisional application No. 63/489,297, filed on Mar. 9, 2023.

(51) Int. Cl. F03G 4/02; F03B 17/06

(52) U.S. Cl. CPC F03G 4/02; F03B 17/06; F05B 2220/706

(57) ABSTRACT

A geothermal power system is configured to convert pressure energy of a geothermal fluid into electricity using a first generator, and convert heat energy of the geothermal fluid into electricity using a second generator. The first generator is coupled to a turbine, through which the geothermal fluid passes. The second generator is coupled to an expander of a binary cycle power plant. A working fluid of the binary cycle power plant is heated by the geothermal fluid before passing through the expander. The geothermal fluid is produced from a subterranean formation. In some aspects, the geothermal power system is operated such that a fracture located in the subterranean formation is maintained in an open condition.

### CROSS-REFERENCE TO RELATED APPLICATIONS

This application is an International Patent Application under the Patent Cooperation Treaty and claims priority to and the benefit of U.S. Provisional Patent Application Ser. No. 63/489,297 filed Mar. 9, 2023 and titled Enhanced Geothermal Energy System, the disclosure of which is incorporated herein in its entirety by this reference.

### BACKGROUND

### Field

Embodiments of the present disclosure generally relate to geothermal power systems and processes, and particularly to the recovery of geothermal heat energy and pressure energy to perform useful work, such as generating electricity.

### Description of the Related Art

Geothermal energy is a type of renewable energy generated within the earth. A geothermal fluid (such as water, steam, brine, or hydrocarbons) is heated in a subterranean geological formation by the earth's natural internal temperature. The heated geothermal fluid is produced to the earth's surface. The enthalpy of the geothermal fluid includes a heat energy component and a pressure-volume energy component. Typically, the heat energy component is greater than the pressure-volume energy component. At the earth's surface, the heat energy component is used to perform useful work, such as heating buildings or generating electricity in a geothermal power system. However, the pressure-volume energy component is usually wasted, such as by venting. After performing useful work, the geothermal fluid is reinjected into the subterranean formation, reheated by the subterranean formation, then produced again to the earth's surface to perform useful work.

Some geothermal power systems generate electricity by using the geothermal fluid to drive a steam turbine. However, where the produced geothermal fluid is at or below about 180 degrees C, geothermal power systems typically incorporate a binary cycle power plant to generate electricity. A heat exchanger of the binary cycle power plant transfers heat, but not pressure, from the geothermal fluid to a working fluid of the binary cycle power plant.

In an example, operation of the binary cycle power plant is based on the Brayton Cycle, in which the heated working fluid passes through a turbine, which drives a generator. In another example, operation of the binary cycle power plant is based on the Organic Rankine Cycle, in which the heated working fluid passes through an expander, which drives a generator. Typically, binary cycle power plants utilize only the heat energy component of the enthalpy of the geothermal fluid. The pressure-volume energy component is wasted, such as by venting.

The efficiency of a geothermal power system depends on the amount of energy (in the form of heat energy and pressure-volume energy) that can be transferred from the subterranean geological formation to the geothermal fluid, and depends on the proportion of that energy that is converted into useful work. Typically, the efficiency of converting geothermal energy into electricity is less than 15 percent.

Thus, there is a need for improved systems and processes that facilitate the conversion of geothermal energy into electricity.

### SUMMARY

The present disclosure generally relates to geothermal power systems and processes, and particularly to the recovery of geothermal heat energy and pressure energy to perform useful work, such as generating electricity. In one implementation, a method of operating a geothermal power system includes producing a first fluid from a subterranean formation, converting pressure energy of the first fluid into electricity using a first generator, and converting heat energy of the first fluid into electricity using a second generator.

In another implementation, a method of operating a geothermal power system includes producing a first fluid from a subterranean formation, flowing the first fluid through a turbine coupled to a first generator, and generating electricity using the first generator. The method further includes transferring heat energy from the first fluid to a second fluid at a heat exchanger, conveying the second fluid from the heat exchanger and through an expander coupled to a second generator, and generating electricity using the second generator.

In another implementation, a geothermal power system includes a binary cycle power plant configured to operate with a working fluid. The binary cycle power plant includes a heat exchanger, an expander fluidically coupled to the heat exchanger, and a first generator coupled to the expander. The geothermal power system further includes a turbine configured to operate with a geothermal fluid. The turbine is fluidically coupled to the heat exchanger, and a second generator is coupled to the turbine.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of the scope of the disclosure, as the disclosure may admit to other equally effective embodiments.

FIG. 1 schematically illustrates a geothermal power system.

FIG. 2 schematically illustrates another geothermal power system.

FIG. 3 schematically illustrates another geothermal power system.

FIG. 4 schematically illustrates another geothermal power system.

FIG. 5 is a flow diagram of a method of operating a geothermal power system.

FIG. 6 is a flow diagram of a method of operating a geothermal power system.

To facilitate understanding, identical reference numerals have been used, where possible, to designate identical elements that are common to the figures. It is contemplated that elements and features of one embodiment or example may be beneficially incorporated in other embodiments or examples without further recitation.

### DETAILED DESCRIPTION

The present disclosure concerns geothermal power systems and processes, and particularly to the recovery of geothermal energy to perform useful work, such as generating electricity. The recovery of geothermal energy includes the conversion of both heat energy and pressure-volume energy of a geothermal fluid into useful work. Geothermal power systems of the present disclosure include a binary cycle power plant that recovers heat energy from a geothermal fluid. The binary cycle power plant is integrated with a provision in the geothermal power systems to recover pressure-volume energy of the geothermal fluid. The present disclosure also concerns the integration of geothermal power systems with various subsurface geothermal well configurations.

Whereas the typical efficiency of converting geothermal heat energy plus pressure-volume energy into electricity is less than 15 percent, conversion of just the pressure-volume energy component alone to electricity can reach 65% to 95% efficiency. Using the pressure-volume energy component to perform useful work according to the systems and processes of the present disclosure can increase the amount of electricity generated by 15% to 60% compared to the electricity generated by a binary cycle power plant alone.

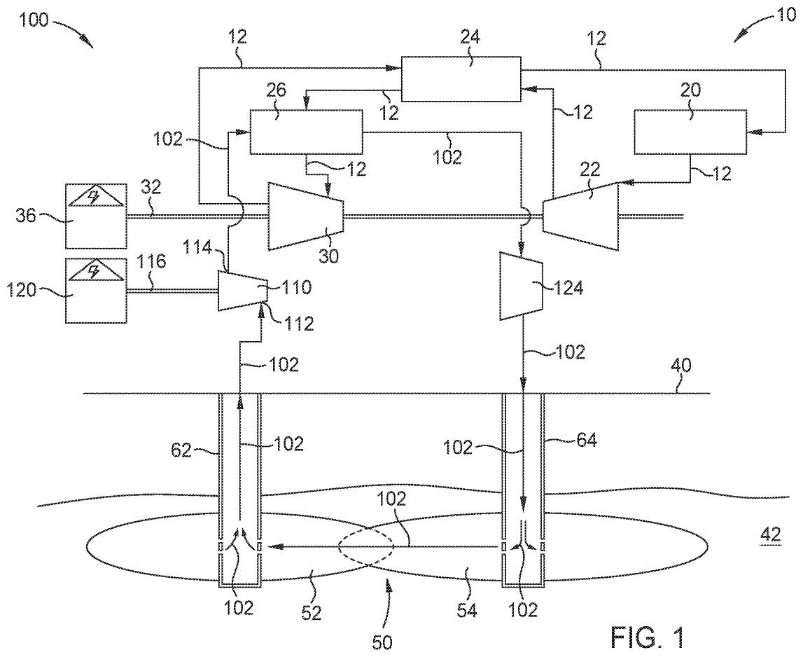

FIG. 1 schematically illustrates a geothermal power system 100. The geothermal power system 100 includes a binary cycle power plant 10. In some embodiments, operation of the binary cycle power plant 10 is based on the Brayton Cycle. In some embodiments, operation of the binary cycle power plant 10 is based on the Rankine Cycle. In some embodiments, operation of the binary cycle power plant 10 is based on the Organic Rankine Cycle.

The binary cycle power plant 10 utilizes a working fluid (represented by arrows 12), such as water, steam, brine, a refrigerant, a supercritical fluid, carbon dioxide, ammonia, an organic compound (e.g., a hydrocarbon, a fluorocarbon, etc.), or any combination thereof. The working fluid 12 flows from a condenser 20 to a pressure booster 22, such as a pump (e.g. a single phase pump, a multi-phase pump, a centrifugal pump, or a positive displacement pump), a compressor, or the like. The pressure booster 22 increases the pressure of the working fluid 12, and moves the working fluid 12 through a recuperator 24 to a heat exchanger 26, where the working fluid 12 is heated.

The heated working fluid 12 then flows to an expander 30, such as a turbine, a turbo-expander, or the like. The working fluid 12 drives the expander 30 to rotate a shaft 32. The shaft 32 is coupled to a generator 36. In an example, the shaft 32 is coupled to the generator 36 via a gearbox. The shaft 32 drives the generator 36 to produce electricity. The working fluid 12 loses pressure in driving the expander 30, and a temperature of the working fluid 12 drops. The working fluid 12 exits the expander 30, and passes through the recuperator 24, and back to the condenser 20.

In some embodiments, the pressure booster 22 and the expander 30 are coupled to a common shaft, such as shaft 32. In some embodiments, the pressure booster 22, the expander 30, and the generator 36 are coupled to a common shaft, such as shaft 32.

The geothermal power system 100 utilizes a geothermal fluid (represented by arrows 102). The geothermal fluid 102 may include any fluid (such as water, steam, brine, a refrigerant, a supercritical fluid, carbon dioxide, ammonia, an organic compound, or any combination thereof) that is injected into, or produced out of, a subterranean formation 42. In some embodiments, the subterranean formation 42 is a geothermal subterranean formation.

The geothermal fluid 102 is heated, or is maintained at an elevated temperature, by the subterranean formation 42. In an example, the temperature of the geothermal fluid is at or about 150 degrees C or higher, such as 175 degrees C or higher, 200 degrees C or higher, 250 degrees C or higher, or 300 degrees C or higher. The geothermal fluid 102 is maintained at an elevated pressure in the subterranean formation 42. In an example, the pressure of the geothermal fluid 102 in the subterranean formation 42 is at or 3 MPa or higher, such as 5 MPa or higher, 10 MPa or higher, 20 MPa or higher, 30 MPa or higher, 40 MPa or higher, or 50 MPa or higher. In some embodiments, the geothermal fluid 102 is geopressured. In an example, the geothermal fluid 102 may be a geopressured-geothermal fluid. The geothermal fluid 102 flows from the subterranean formation 42 into a production well 62. In some embodiments, the geothermal fluid 102 flows from the subterranean formation 42 into the production well 62 via one or more fractures 52 in the subterranean formation 42 at the production well 62.

The geothermal fluid 102 flows from the production well 62 to one or more turbines 110. In some embodiments, the one or more turbines 110 are Pelton Turbines. In some embodiments, the one or more turbines 110 are other types of turbine, such as Francis Turbines or Kaplan Turbines. In some embodiments, the one or more turbines 110 are located at the earth's surface 40. In some embodiments, the one or more turbines 110 are arranged in a series configuration such that the geothermal fluid 102 flows to a first turbine 110 and then to a second turbine 110. In some embodiments, the one or more turbines 110 are arranged in a parallel configuration. In an example, a first portion of the geothermal fluid 102 flows to a first turbine 110, and a different second portion of the geothermal fluid 102 flows simultaneously to a second turbine 110. In another example, one of the first or second turbines 110 is offline (such as for maintenance), and the geothermal fluid 102 flows to the other of the first or second turbines 110.

Each of the one or more turbines 110 is coupled to a shaft 116. Each shaft 116 is coupled to a corresponding generator 120. In an example, each shaft 116 is coupled to the corresponding generator 120 via a gearbox. Each shaft 116 drives the corresponding generator 120 to produce electricity.

Each of the one or more turbines 110 has an inlet 112 and an outlet 114. The geothermal fluid 102 flows from the inlet 112, and through the turbine 110 to the outlet 114. A pressure of the geothermal fluid 102 at the inlet 112 of each of the one or more turbines 110 is greater than the pressure of the geothermal fluid 102 at the outlet 114 of each of the one or more turbines 110. The geothermal fluid 102 experiences a drop in pressure from the inlet 112 to the outlet 114 of each turbine 110 as the geothermal fluid 102 drives each turbine 110 to rotate the corresponding shaft 116, and drive the corresponding generator 120 to produce electricity. In an example, the pressure of the geothermal fluid 102 at the outlet 114 of each turbine 110 is at or about 10 bar or less, such as 5 bar or less, 4 bar or less, 3 bar or less, or 2 bar or less.

The geothermal fluid 102 flows from the outlet 114 of each of the one or more turbines 110 to the heat exchanger 26. In some embodiments, the temperature of the geothermal fluid 102 entering the heat exchanger 26 is similar to the temperature of the geothermal fluid 102 at the production well 62. Heat is transferred from the geothermal fluid 102 to the working fluid 12 as the geothermal fluid 102 flows through the heat exchanger 26. In an example, the temperature of the geothermal fluid 102 upon exiting the heat exchanger 26 is at or about 100 degrees C or less, such as 90 degrees C or less, 80 degrees C or less, 70 degrees C or less, 60 degrees C or less, or 50 degrees C or less. The geothermal fluid 102 flows from the heat exchanger 26 to one or more pumps 124. Exemplary pumps 124 include single phase pumps, multi-phase pumps, centrifugal pumps, positive displacement pumps, or the like. In some embodiments, the geothermal fluid 102 flows from the heat exchanger 26 to a reservoir, such as a pond, before flowing to the one or more pumps 124. The one or more pumps 124 increase a pressure of the geothermal fluid 102, and inject the geothermal fluid 102 into an injection well 64. In some embodiments, the one or more pumps 124 are operated at an efficiency of 90% or above, such as 92% or above, or 95% or above.

The geothermal fluid 102 flows from the injection well 64 into the subterranean formation 42. In some embodiments, the geothermal fluid 102 flows from the injection well 64 into the subterranean formation 42 via one or more fractures 54 in the subterranean formation 42. The geothermal fluid 102 flows in the subterranean formation 42 from the injection well 64 towards the production well 62. The geothermal fluid 102 is heated by the subterranean formation 42. In some embodiments, the producing of the geothermal fluid 102 from the subterranean formation 42 via the production well 62, and the injecting of the geothermal fluid 102 into the subterranean formation 42 at the injection well 64 are performed simultaneously.

A fracture network 50 in the subterranean formation 42 includes the one or more fractures 54 and the one or more fractures 52. In some embodiments, the one or more factures 54 intersect with one or more of the one or more fractures 52. In some embodiments, the one or more factures 54 are contiguous with one or more of the one or more fractures 52. Maintaining the one or more fractures 54 and the one or more fractures 52 of the fracture network 50 in an open condition while producing the geothermal fluid 102 and while injecting the geothermal fluid 102 facilitates effective heating of the geothermal fluid 102 by the subterranean formation 42.

In some embodiments, the production well 62 is operated such that the one or more fractures 52 remain open while the geothermal fluid 102 is produced from the subterranean formation 42 into the production well 62. In an example, a pressure of the geothermal fluid 102 within the one or more fractures 52 is maintained at a magnitude that is greater than a closure pressure of the one or more fractures 52. In another example, a pressure of the geothermal fluid 102 within the one or more fractures 52 is maintained at a magnitude that is greater than an opening pressure of the one or more fractures 52. In another example, a pressure of the geothermal fluid 102 within the one or more fractures 52 is maintained at a magnitude that is between the opening pressure and the closure pressure of the one or more fractures 52. In another example, a pressure of the geothermal fluid 102 within the one or more fractures 52 is maintained at a magnitude that is greater than a reopening pressure of the one or more fractures 52. In another example, a pressure of the geothermal fluid 102 within the one or more fractures 52 is maintained at a magnitude that is between the reopening pressure and the closure pressure of the one or more fractures 52.

In some embodiments, operation of the production well 62 such that the one or more fractures 52 remain open is performed by regulating a pressure within the production well 62 by a control valve, such as a choke. In some embodiments, operation of the production well 62 such that the one or more fractures 52 remain open is performed by regulating a pressure within the production well 62 by controlling the operation of the one or more turbines 110. In an example, the pressure drop experienced by the geothermal fluid 102 flowing through the one or more turbines 110 creates a back-pressure on the geothermal fluid 102 exiting the production well 62.

In some embodiments, operation of a control valve is omitted when regulating a pressure within the production well 62 by controlling the operation of the one or more turbines 110.

In some embodiments, the injection well 64 is operated such that the one or more fractures 54 remain open while the geothermal fluid 102 is injected into the subterranean formation 42 from the injection well 64. In an example, a pressure of the geothermal fluid 102 within the one or more fractures 54 is maintained at a magnitude that is greater than a closure pressure of the one or more fractures 54. In another example, a pressure of the geothermal fluid 102 within the one or more fractures 54 is maintained at a magnitude that is greater than an opening pressure of the one or more fractures 54. In another example, a pressure of the geothermal fluid 102 within the one or more fractures 54 is maintained at a magnitude that is between the opening pressure and the closure pressure of the one or more fractures 54. In another example, a pressure of the geothermal fluid 102 within the one or more fractures 54 is maintained at a magnitude that is greater than a reopening pressure of the one or more fractures 54. In another example, a pressure of the geothermal fluid 102 within the one or more fractures 54 is maintained at a magnitude that is between the reopening pressure and the closure pressure of the one or more fractures 54.

In some embodiments, operation of the injection well 64 such that the one or more fractures 54 remain open is performed by regulating the one or more pumps 124.

The geothermal fluid 102 is at a relatively high temperature and at a relatively high pressure upon exiting the production well 62 and at the inlet 112 of each of the one or more turbines 110. The geothermal fluid 102 remains at a relatively high temperature, but is at a relatively low pressure at the outlet 114 of each of the one or more turbines 110, and upon entering the heat exchanger 24. The geothermal fluid 102 is at a relatively low temperature and remains at a relatively low pressure upon exiting the heat exchanger 26 and upon entering the one or more pumps 124. It is contemplated that the geothermal fluid 102 may experience a relatively minor drop in pressure as the geothermal fluid 102 passes through the heat exchanger 26. The geothermal fluid 102 remains at a relatively low temperature, but is at a relatively high pressure upon exiting the one or more pumps 124 and upon entering the injection well 64. The geothermal fluid 102 is heated by the subterranean formation 42 as the geothermal fluid 102 moves through the fracture network 50 between the injection well 64 and the production well 62.

Pressure energy of the geothermal fluid 102 is used to generate electricity by flowing the geothermal fluid 102 through the one or more turbines 110 coupled to corresponding generators 120. Heat energy of the geothermal fluid 102 is used to generate electricity by transferring heat from the geothermal fluid 102 to the working fluid 12, which becomes a dry saturated vapor, then adiabatically expanding the working fluid 12 through the expander 30 to drive the generator 36.

In some embodiments, the working fluid 12 in the binary cycle power plant 10 is segregated from the geothermal fluid 102. In some embodiments, the working fluid 12 may include at least a portion of the geothermal fluid 102. In some embodiments, the geothermal fluid 102 may include at least a portion of the working fluid 12.

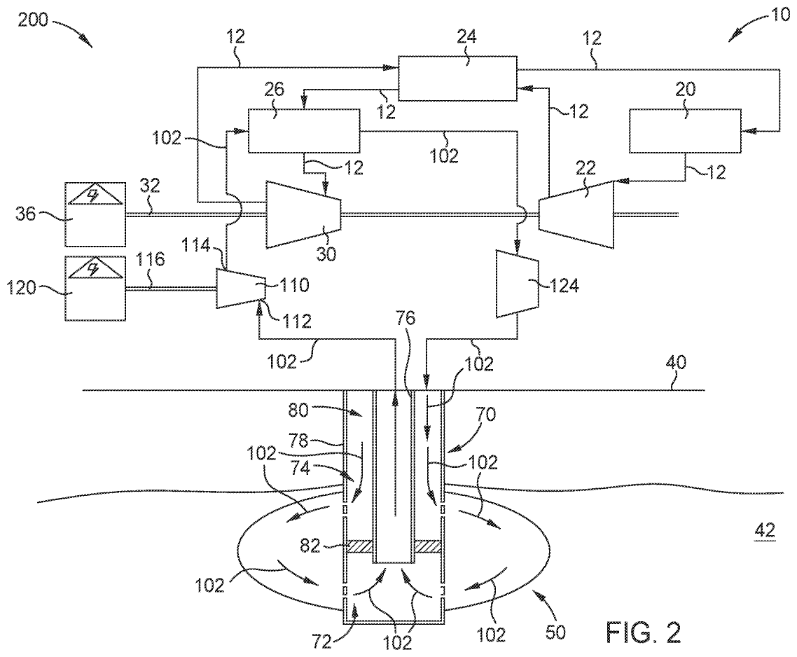

FIG. 2 schematically illustrates a geothermal power system 200. The geothermal power system 200 includes the binary cycle power plant 10 described above. The geothermal power system 200 includes the one or more turbines 110, the corresponding generators 120, and the one or more pumps 124 of the geothermal power system 100.

A well 70 functions as the production well 62 and the injection well 64. In some embodiments, a single well 70 that functions as the production well 62 and the injection well 64 is fluidically coupled to the one or more turbines 110 and to the one or more pumps 124. In some embodiments, the one or more turbines 110 and the one or more pumps 124 are coupled to a single well 70. In some embodiments, the one or more turbines 110 and the one or more pumps 124 are coupled to a plurality of wells 70, each of which being configured to function as the production well 62 and the injection well 64.

The well 70 includes a production zone 72 and an injection zone 74. Fluids in the subterranean formation flow into the well 70 at the production zone 72. Fluids flow from the well 70 into the subterranean formation 42 at the injection zone 74. The fracture network 50 in the subterranean formation 42 is fluidically coupled to the production zone 72 and to the injection zone 74.

In some embodiments, the well 70 is operated such that the fracture network 50 remains open while the geothermal fluid 102 is produced from the subterranean formation 42 into the production zone 72. In some embodiments, the well 70 is operated such that the fracture network 50 remains open while the geothermal fluid 102 is injected into the subterranean formation 42 at the injection zone 74. In an example, a pressure of the geothermal fluid 102 within the fracture network 50 is maintained at a magnitude that is greater than a closure pressure of one or more fractures of the fracture network 50. In another example, a pressure of the geothermal fluid 102 within the fracture network 50 is maintained at a magnitude that is greater than an opening pressure of one or more fractures of the fracture network 50. In another example, a pressure of the geothermal fluid 102 within the fracture network 50 is maintained at a magnitude that is between the opening pressure and the closure pressure of one or more fractures of the fracture network 50. In another example, a pressure of the geothermal fluid 102 within the fracture network 50 is maintained at a magnitude that is greater than a reopening pressure of one or more fractures of the fracture network 50. In another example, a pressure of the geothermal fluid 102 within the fracture network 50 is maintained at a magnitude that is between the reopening pressure and the closure pressure of one or more fractures of the fracture network 50.

In some embodiments, operation of the well 70 such that the fracture network 50 remains open is performed by regulating a pressure within the well 70 by a control valve, such as a choke. In some embodiments, operation of the well 70 such that fracture network 50 remains open is performed by regulating a pressure within the well 70 by controlling the operation of the one or more turbines 110. In an example, the pressure drop experienced by the geothermal fluid 102 flowing through the one or more turbines 110 creates a back-pressure on the geothermal fluid 102 exiting the well 70. In some embodiments, operation of a control valve is omitted when regulating a pressure within the well 70 by controlling the operation of the one or more turbines 110. In some embodiments, operation of the well 70 such that the fracture network 50 remains open is performed by regulating the one or more pumps 124.

The well 70 includes a tubing string 76 installed inside a casing string 78. A packer 82 seals an annulus 80 between the tubing string 76 and the casing string 78. The packer 82 is located between the production zone 72 and the injection zone 74. The geothermal fluid 102 in the subterranean formation 42 enters the well 70 at the production zone 72, and flows up the tubing string 76. The geothermal fluid 102 flows from the tubing string 76 of the well 70 to the one or more turbines 110. Operation of the one or more turbines 110, the corresponding generators 120, the heat exchanger 26, and the one or more pumps 124 is as described above. The one or more pumps 124 inject the geothermal fluid 102 into the annulus 80 of the well 70. The geothermal fluid 102 exits the well 70 at the injection zone 74, and enters the subterranean formation 42.

The geothermal fluid 102 flows in the subterranean formation 42 from the injection zone 74 of the well 70 towards the production zone 72 of the well 70. The geothermal fluid 102 is heated by the subterranean formation 42. In some embodiments, the producing of the geothermal fluid 102 from the subterranean formation 42 via the well 70, and the injecting of the geothermal fluid 102 into the subterranean formation 42 at the well 70 are performed simultaneously.

The geothermal fluid 102 is at a relatively high temperature and at a relatively high pressure upon exiting the well 70 and at the inlet 112 of each of the one or more turbines 110. The geothermal fluid 102 is at a relatively high temperature, but is at a relatively low pressure at the outlet of each of the one or more turbines 110, and upon entering the heat exchanger 26. The geothermal fluid 102 is at a relatively low temperature and remains at a relatively low pressure upon exiting the heat exchanger 26 and upon entering the one or more pumps 124. It is contemplated that the geothermal fluid 102 may experience a relatively minor drop in pressure as the geothermal fluid 102 passes through the heat exchanger 26. The geothermal fluid 102 remains at a relatively low temperature, but is at a relatively high pressure upon exiting the one or more pumps 124 and upon entering the well 70. The geothermal fluid 102 is heated by the subterranean formation 42 as the geothermal fluid 102 moves through the fracture network 50 between the injection zone 74 of the well 70 and the production zone 72 of the well 70.

In some embodiments, the working fluid 12 in the binary cycle power plant 10 is segregated from the geothermal fluid 102. In some embodiments, the working fluid 12 may include at least a portion of the geothermal fluid 102. In some embodiments, the geothermal fluid 102 may include at least a portion of the working fluid 12.

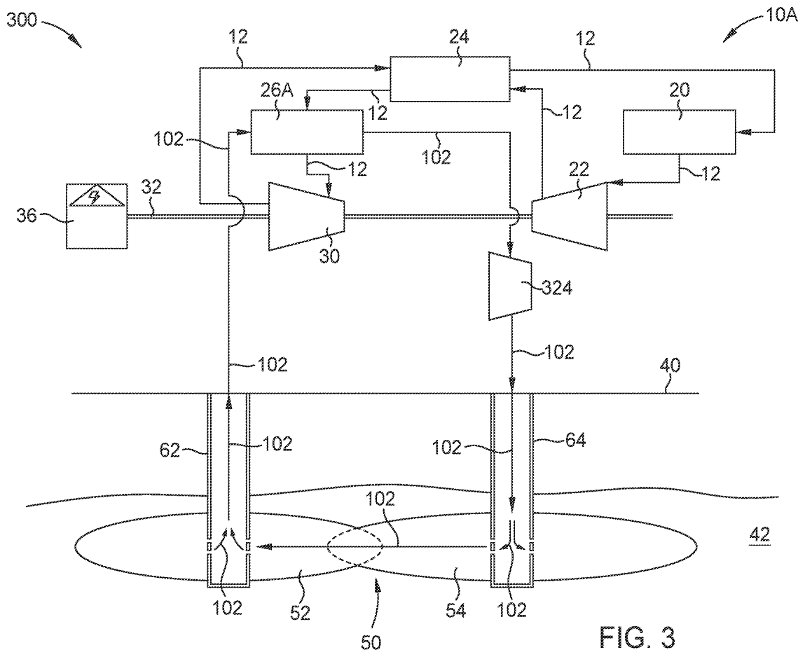

FIG. 3 schematically illustrates a geothermal power system 300. Geothermal power system 300 omits the one or more turbines 110. The geothermal power system 300 includes a binary cycle power plant 10A. The binary cycle power plant 10A is similar to binary cycle power plant 10 described above, except that heat exchanger 26A replaces heat exchanger 26. Heat exchanger 26A is configured to accommodate geothermal fluid 102 at a higher pressure than the pressure at which heat exchanger 26 operates. In an example, heat exchanger 26A includes components having a greater wall thickness than equivalent components of heat exchanger 26.

The production well 62, injection well 64, and fracture network 50 are as described above with respect to FIG. 1. Geothermal fluid 102 flows from the production well 62 to the heat exchanger 26A. In some embodiments, the temperature of the geothermal fluid 102 entering the heat exchanger 26A is similar to the temperature of the geothermal fluid 102 at the production well 62. The heat exchanger 26A transfers heat from the geothermal fluid 102 to the working fluid 12 of the binary cycle power plant 10A. In an example, the temperature of the geothermal fluid 102 upon exiting the heat exchanger 26A is at or about 100 degrees C or less, such as 90 degrees C or less, 80 degrees C or less, 70 degrees C or less, 60 degrees C or less, or 50 degrees C or less. The binary cycle power plant 10A operates similarly to the binary cycle power plant 10, as described above.

The geothermal fluid 102 flows from the heat exchanger 26A to one or more pumps 324. Exemplary pumps include single phase pumps, multi-phase pumps, centrifugal pumps, positive displacement pumps, or the like. The one or more pumps 324 increase a pressure of the geothermal fluid 102, and inject the geothermal fluid 102 into the injection well 64. In some embodiments, the one or more pumps 324 are operated at an efficiency of 90% or above, such as 92% or above, or 95% or above. The increase in pressure of the geothermal fluid 102 provided by the one or more pumps 324 is less than the increase in pressure of the geothermal fluid 102 provided by the one or more pumps 124 depicted in FIGS. 1 and 2. In some embodiments, the one or more pumps 324 are booster pumps.

The geothermal fluid 102 flows from the injection well 64 into the subterranean formation 42. In some embodiments, the geothermal fluid 102 flows from the injection well 64 into the subterranean formation 42 via the one or more fractures 54 in the subterranean formation 42 at the injection well 64. The geothermal fluid 102 flows in the subterranean formation 42 from the injection well 64 towards the production well 62. The geothermal fluid 102 is heated by the subterranean formation 42. In some embodiments, the producing of the geothermal fluid 102 from the subterranean formation 42 via the production well 62, and the injecting of the geothermal fluid 102 into the subterranean formation 42 at the injection well 64 are performed simultaneously.

Geothermal power system 300 maintains the geothermal fluid 102 at relatively high pressures throughout the passage of the geothermal fluid 102 from the production well 62 to the injection well 64. In an example, control valves, such as chokes, between the production well 62 and the heat exchanger 26A are operated at or near fully open. In some embodiments, the production well 62 is operated such that the one or more fractures 52 remain open while the geothermal fluid 102 is produced from the subterranean formation 42 into the production well 62. In an example, a pressure of the geothermal fluid 102 within the one or more fractures 52 is maintained at a magnitude that is greater than a closure pressure of the one or more fractures 52. In another example, a pressure of the geothermal fluid 102 within the one or more fractures 52 is maintained at a magnitude that is greater than an opening pressure of the one or more fractures 52. In another example, a pressure of the geothermal fluid 102 within the one or more fractures 52 is maintained at a magnitude that is between the opening pressure and the closure pressure of the one or more fractures 52. In another example, a pressure of the geothermal fluid 102 within the one or more fractures 52 is maintained at a magnitude that is greater than a reopening pressure of the one or more fractures 52. In another example, a pressure of the geothermal fluid 102 within the one or more fractures 52 is maintained at a magnitude that is between the reopening pressure and the closure pressure of the one or more fractures 52.

In some embodiments, the injection well 64 is operated such that the one or more fractures 54 remain open while the geothermal fluid 102 is injected into the subterranean formation 42 from the injection well 64. In an example, a pressure of the geothermal fluid 102 within the one or more fractures 54 is maintained at a magnitude that is greater than a closure pressure of the one or more fractures 54. In another example, a pressure of the geothermal fluid 102 within the one or more fractures 54 is maintained at a magnitude that is greater than an opening pressure of the one or more fractures 54. In another example, a pressure of the geothermal fluid 102 within the one or more fractures 54 is maintained at a magnitude that is between the opening pressure and the closure pressure of the one or more fractures 54. In another example, a pressure of the geothermal fluid 102 within the one or more fractures 54 is maintained at a magnitude that is greater than a reopening pressure of the one or more fractures 54. In another example, a pressure of the geothermal fluid 102 within the one or more fractures 54 is maintained at a magnitude that is between the reopening pressure and the closure pressure of the one or more fractures 54.

In some embodiments, operation of the injection well 64 such that the one or more fractures 54 remain open is performed by regulating the one or more pumps 324.

The geothermal fluid 102 is at a relatively high temperature and at a relatively high pressure upon exiting the production well 62 and upon entering the heat exchanger 26A. The geothermal fluid 102 is at a relatively low temperature, but remains at a relatively high pressure upon exiting the heat exchanger 26A and upon entering the one or more pumps 324. It is contemplated that the geothermal fluid 102 may experience a relatively minor drop in pressure as the geothermal fluid 102 passes through the heat exchanger 26A. The geothermal fluid 102 remains at a relatively low temperature, but is boosted to a relatively higher pressure upon exiting the one or more pumps 324 and upon entering the injection well 64. The geothermal fluid 102 is heated by the subterranean formation 42 as the geothermal fluid 102 moves through the fracture network 50 between the injection well 64 and the production well 62.

In some embodiments, the working fluid 12 in the binary cycle power plant 10A is segregated from the geothermal fluid 102. In some embodiments, the working fluid 12 may include at least a portion of the geothermal fluid 102. In some embodiments, the geothermal fluid 102 may include at least a portion of the working fluid 12.

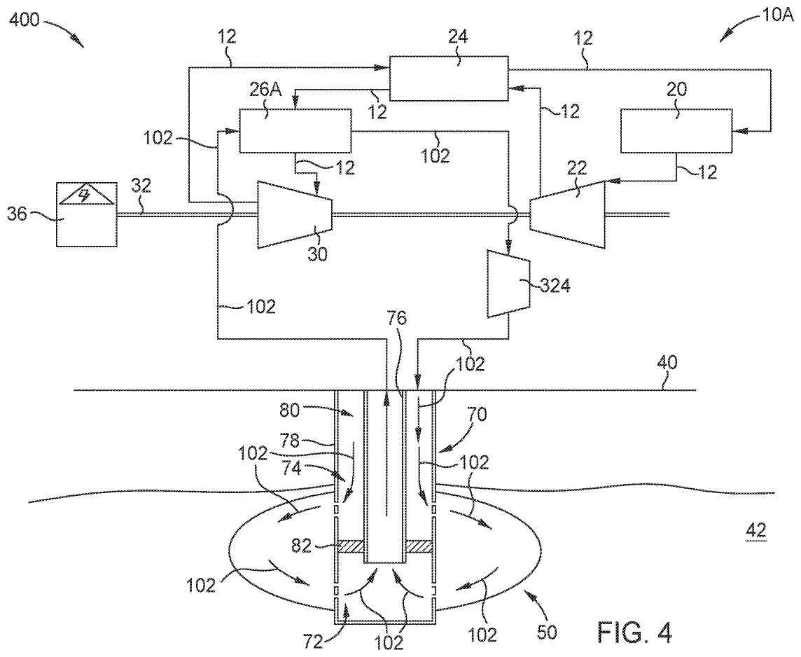

FIG. 4 schematically illustrates a geothermal power system 400. Geothermal power system 400 includes the binary cycle power plant 10A described above with respect to FIG. 3. The well 70 and fracture network 50 are as described above with respect to FIG. 2. The well 70 functions as the production well 62 and the injection well 64. In some embodiments, a single well 70 that functions as the production well 62 and the injection well 64 is fluidically coupled to the one or more turbines 110 and to the one or more pumps 324. In some embodiments, the one or more turbines 110 and the one or more pumps 324 are coupled to a single well 70. In some embodiments, the one or more turbines 110 and the one or more pumps 324 are coupled to a plurality of wells 70, each of which being configured to function as the production well 62 and the injection well 64.

The geothermal fluid 102 flows from the tubing string of the well 70 to the heat exchanger 26A. Operation of the heat exchanger 26A and the one or more pumps 324 is as described above. The one or more pumps 324 inject the geothermal fluid 102 into the annulus 80 of the well 70. The geothermal fluid 102 exits the well 70 at the injection zone 74, and enters the subterranean formation 42.

The geothermal fluid 102 flows in the subterranean formation 42 from the injection zone 74 of the well 70 towards the production zone 72 of the well 70. The geothermal fluid 102 is heated by the subterranean formation 42. In some embodiments, the producing of the geothermal fluid 102 from the subterranean formation 42 via the well 70, and the injecting of the geothermal fluid 102 into the subterranean formation 42 at the well 70 are performed simultaneously.

Geothermal power system 400 maintains the geothermal fluid 102 at relatively high pressures throughout the passage of the geothermal fluid 102 from the production zone 72 of the well 70 to the injection zone 74 of the well 70. In an example, control valves, such as chokes, between the production zone 72 of the well 70 and the heat exchanger 26A are operated at or near fully open. In some embodiments, the well 70 is operated such that the fracture network 50 remains open while the geothermal fluid 102 is produced from the subterranean formation 42 into the production zone 72.

In some embodiments, the well 70 is operated such that the fracture network 50 remains open while the geothermal fluid 102 is injected into the subterranean formation 42 at the injection zone 74. In an example, a pressure of the geothermal fluid 102 within the fracture network 50 is maintained at a magnitude that is greater than a closure pressure of one or more fractures of the fracture network 50. In another example, a pressure of the geothermal fluid 102 within the fracture network 50 is maintained at a magnitude that is greater than an opening pressure of one or more fractures of the fracture network 50. In another example, a pressure of the geothermal fluid 102 within the fracture network 50 is maintained at a magnitude that is between the opening pressure and the closure pressure of one or more fractures of the fracture network 50. In another example, a pressure of the geothermal fluid 102 within the fracture network 50 is maintained at a magnitude that is greater than a reopening pressure of one or more fractures of the fracture network 50. In another example, a pressure of the geothermal fluid 102 within the fracture network 50 is maintained at a magnitude that is between the reopening pressure and the closure pressure of one or more fractures of the fracture network 50. In some embodiments, operation of the well 70 such that the fracture network 50 remains open is performed by regulating the one or more pumps 324.

The geothermal fluid 102 is at a relatively high temperature and at a relatively high pressure upon exiting the well 70 and upon entering the heat exchanger 26A. The geothermal fluid 102 is at a relatively low temperature, but remains at a relatively high pressure upon exiting the heat exchanger 26A and upon entering the one or more pumps 324. It is contemplated that the geothermal fluid 102 may experience a relatively minor drop in pressure as the geothermal fluid 102 passes through the heat exchanger 26A. The geothermal fluid 102 remains at a relatively low temperature, but is boosted to a relatively higher pressure upon exiting the one or more pumps 324 and upon entering the well 70. The geothermal fluid 102 is heated by the subterranean formation 42 as the geothermal fluid 102 moves through the fracture network 50 between the injection zone 74 of the well 70 and the production zone 72 of the well 70.

In some embodiments, the working fluid 12 in the binary cycle power plant 10A is segregated from the geothermal fluid 102. In some embodiments, the working fluid 12 may include at least a portion of the geothermal fluid 102. In some embodiments, the geothermal fluid 102 may include at least a portion of the working fluid 12.

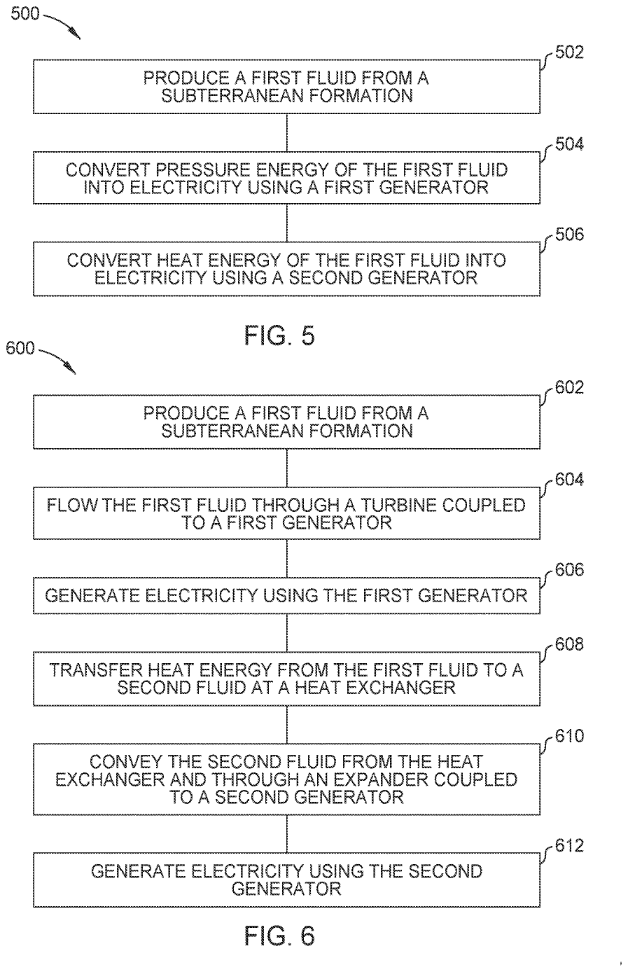

FIG. 5 is a flow diagram of a method 500 of operating a geothermal power system. Operation 502 includes producing a first fluid from a subterranean formation. In some embodiments, operation 502 includes producing the first fluid from a production well, such as described herein. In some embodiments, operation 502 includes producing the first fluid from a well that is configured for simultaneous production of fluid and injection of fluid, such as described herein. In some embodiments, the subterranean formation is a geothermal subterranean formation. In some embodiments, the first fluid is a geothermal fluid. In some embodiments, the geothermal fluid includes any one or more of water, steam, brine, carbon dioxide, ammonia, an organic compound, or any combination thereof.

Operation 504 includes converting pressure energy of the first fluid into electricity using a first generator. In some embodiments, operation 504 includes flowing the first fluid through a turbine coupled to the first generator. In some embodiments, flowing the first fluid through the turbine includes applying a back-pressure to the first fluid. In some embodiments, the back-pressure applied to the first fluid maintains a fracture located in the subterranean formation in an open condition.

Operation 506 includes converting heat energy of the first fluid into electricity using a second generator. In some embodiments, operation 506 includes transferring heat energy from the first fluid to a second fluid at a heat exchanger. In some embodiments, the second fluid is a working fluid of a binary cycle power plant, such as described herein. In some embodiments, the working fluid includes any one or more of water, steam, brine, a refrigerant, carbon dioxide, ammonia, an organic compound, or any combination thereof.

In some embodiments, operation 506 includes conveying the second fluid from the heat exchanger to an expander coupled to the second generator. In some embodiments, operation 506 includes flowing the second fluid through the expander. In some embodiments, the second fluid circulates in a binary cycle power plant, such as described herein. In some embodiments, the binary cycle power plant includes the expander, such as described herein. In some embodiments, operation 506 is performed after operation 504. In an example, operation 506 includes conveying the first fluid from the turbine to the heat exchanger.

In some embodiments, method 500 includes injecting the first fluid back into the subterranean formation. In some embodiments, injecting the first fluid back into the subterranean formation includes injecting the first fluid into an injection well, such as described herein. In some embodiments, method 500 includes producing the first fluid from a production zone of a well, and injecting the first fluid into an injection zone of the well. In some embodiments, the producing the first fluid from the production zone of the well, and injecting the first fluid into the injection zone of the well are performed simultaneously.

FIG. 6 is a flow diagram of a method 600 of operating a geothermal power system. Operation 602 includes producing a first fluid from a subterranean formation. In some embodiments, operation 602 includes producing the first fluid from a production well, such as described herein. In some embodiments, operation 602 includes producing the first fluid from a well that is configured for simultaneous production of fluid and injection of fluid, such as described herein. In some embodiments, the subterranean formation is a geothermal subterranean formation. In some embodiments, the first fluid is a geothermal fluid. In some embodiments, the geothermal fluid includes any one or more of water, steam, brine, carbon dioxide, ammonia, an organic compound, or any combination thereof.

Operation 604 includes flowing the first fluid through a turbine coupled to a first generator. In some embodiments, operation 604 includes applying a back-pressure to the first fluid. In some embodiments, the back-pressure applied to the first fluid maintains a fracture located in the subterranean formation in an open condition. Operation 606 includes generating electricity using the first generator.

Operation 608 includes transferring heat energy from the first fluid to a second fluid at a heat exchanger. In some embodiments, the second fluid is a working fluid of a binary cycle power plant, such as described herein. In some embodiments, the working fluid includes any one or more of water, steam, brine, a refrigerant, carbon dioxide, ammonia, an organic compound, or any combination thereof. In some embodiments, the second fluid circulates in a binary cycle power plant. In some embodiments, method 600 includes conveying the first fluid from the turbine to the heat exchanger after operation 604 and before operation 608.

Operation 610 includes conveying the second fluid from the heat exchanger and through an expander coupled to a second generator. Operation 612 includes generating electricity using the second generator.

In some embodiments, method 600 includes injecting the first fluid back into the subterranean formation. In some embodiments, injecting the first fluid back into the subterranean formation includes injecting the first fluid into an injection well, such as described herein. In some embodiments, method 600 includes producing the first fluid from a production zone of a well, and injecting the first fluid into an injection zone of the well. In some embodiments, the producing the first fluid from the production zone of the well, and injecting the first fluid into the injection zone of the well are performed simultaneously.

Aspects of the present disclosure present systems and methods for generating electricity using a geothermal fluid. In some aspects, pressure energy of the geothermal fluid is converted into electricity. In some aspects heat energy of the geothermal fluid is converted into electricity. The geothermal fluid is produced from a subterranean formation. In some aspects, the geothermal fluid is reinjected into the subterranean formation. In some aspects, a fracture located in the subterranean formation is maintained in an open condition while producing the geothermal fluid. In some aspects, a fracture located in the subterranean formation is maintained in an open condition while injecting the geothermal fluid into the subterranean formation. Benefits of the systems and methods of the present disclosure include more effective use of geothermal resources compared to conventional geothermal power systems.

It is contemplated that any one or more elements or features of any one disclosed embodiment or example may be incorporated in any one or more other non-mutually exclusive embodiments or examples. While the foregoing is directed to embodiments of the present disclosure, other and further embodiments of the disclosure may be devised without departing from the basic scope thereof, and the scope thereof is determined by the claims that follow.

What is claimed is:

1. A method of operating a geothermal power system, comprising:
producing a first fluid from a subterranean formation;
converting pressure energy of the first fluid into electricity using a first generator; and
converting heat energy of the first fluid into electricity using a second generator.

2. The method of claim 1, wherein converting pressure energy of the first fluid into electricity using the first generator comprises flowing the first fluid through a turbine coupled to the first generator.

3. The method of claim 2, wherein flowing the first fluid through the turbine includes applying a back-pressure to the first fluid.

4. The method of claim 3, wherein the back-pressure applied to the first fluid maintains a fracture located in the subterranean formation in an open condition.

5. The method of claim 1, wherein converting heat energy of the first fluid into electricity using the second generator comprises:
transferring heat energy from the first fluid to a second fluid at a heat exchanger;
conveying the second fluid from the heat exchanger to an expander coupled to the second generator; and
flowing the second fluid through the expander.

6. The method of claim 5, further comprising conveying the first fluid to the heat exchanger from a turbine coupled to the first generator.

7. The method of claim 5, wherein a binary cycle power plant includes the expander.

8. A method of operating a geothermal power system, comprising:
producing a first fluid from a subterranean formation;
flowing the first fluid through a turbine coupled to a first generator;
generating electricity using the first generator;
transferring heat energy from the first fluid to a second fluid at a heat exchanger;
conveying the second fluid from the heat exchanger and through an expander coupled to a second generator; and
generating electricity using the second generator.

9. The method of claim 8, wherein flowing the first fluid through the turbine includes applying a back-pressure to the first fluid.

10. The method of claim 9, wherein the back-pressure applied to the first fluid maintains a fracture located in the subterranean formation in an open condition.

11. The method of claim 8, further comprising conveying the first fluid from the turbine to the heat exchanger.

12. The method of claim 8, wherein the second fluid circulates in a binary cycle power plant.

13. The method of claim 8, further comprising injecting the first fluid back into the subterranean formation.

14. The method of claim 13, wherein:
producing the first fluid from the subterranean formation comprises producing the first fluid from a production zone of a well; and
injecting the first fluid back into the subterranean formation comprises injecting the first fluid into an injection zone of the well.

15. A geothermal power system, comprising:
a binary cycle power plant configured to operate with a working fluid, the binary cycle power plant including:
a heat exchanger;
an expander fluidically coupled to the heat exchanger; and
a first generator coupled to the expander;
a turbine configured to operate with a geothermal fluid, the turbine fluidically coupled to the heat exchanger; and
a second generator coupled to the turbine.

16. The geothermal power system of claim 15, wherein the heat exchanger is downstream of the turbine.

17. The geothermal power system of claim 15, wherein the heat exchanger is upstream of the expander.

18. The geothermal power system of claim 15, wherein the working fluid in the binary cycle power plant is segregated from the geothermal fluid.

19. The geothermal power system of claim 15, further comprising a pump configured to inject the geothermal fluid into a well, wherein the pump is downstream of the heat exchanger.

20. The geothermal power system of claim 19, wherein the turbine is downstream of the well, and receives the geothermal fluid from the well.
